(19) United States
(12) Patent Application Publication
(10) Pub. No.: US 2009/0176473 A1
(43) Pub. Date: Jul. 9, 2009

(54) Mobile Telephone and Method for Storing or Saving Data

(76) Inventor: Albert Fellner, Linz (AT)

Correspondence Address: COLLARD & ROE, P.C., 1077 NORTHERN BOULEVARD, ROSLYN, NY, 11576, US

(21) Appl. No.: 11/885,512

(22) PCT Filed: Mar. 1, 2006
(86) PCT No.: PCT/AT2006/000089

§ 371 Date: Oct. 21, 2008

(30) Foreign Application Priority Data
Mar. 1, 2005 (AT) A 346/2005

(51) Int. Cl. H04M 11/04; H04M 1/00; H04W 4/12; H04M 3/42

(52) U.S. Cl. 455/404.1; 455/566; 455/466; 455/415; 455/556.1; 455/575.1

(57) ABSTRACT

The invention describes a mobile telephone (1) comprising a housing (2) with a first and a second housing part (3, 4) which are connected to one another and can be displaced relative to one another, an electronic unit (5), an electronic memory device (6), a display device (7) and an input unit (8) with a first input device (9) and a second input device (10) disposed separately from the first input device (9). The mobile telephone (1) has two operating levels with different sets of functions, and in a first operating level in a stand-by position access is restricted to only some of all the available functions via the first input device (9). In a second operating level, all the functions can be accessed via the second input device (10) in an extended position. In the stand-by position, entries from the electronic telephone book are displayed via the electronic unit (5) on the display device (7).

The invention relates to a mobile telephone, a method of saving at least one data set in an electronic telephone book of a mobile telephone and a method of securing individual data items of a mobile telephone, as described in claims 1, 43 and 48.

The size of mobile telephones and hence the key pad which comes with them are becoming constantly smaller in new models and using and operating these communication devices is becoming increasingly difficult for older and sight-impaired persons. Mobile telephones are also incorporating ever more technical options and using them is becoming more complicated and more involved.

The underlying objective of this invention is to propose a mobile telephone, a method of saving at least one data set in an electronic telephone book of a mobile telephone and a method of securing individual data of a mobile telephone, which is simple and transparent to operate and enables data to be stored and secured without a high level of knowledge.

This objective is achieved by the invention due to the fact that the mobile telephone has two operating levels with different sets of functions, and in a first operating level access is limited to only a part of the all available functions, in particular to telephone functions such as accepting calls, establishing a telephone connection, terminating a conversation and telephone book selection, and in a second operating level, all the functions can be accessed, and a in stand-by position, only the first input device can be accessed and the first input device acts on the functions of the first operating level, and in the extended position the second input device can be accessed in addition, and the second input device in combination with the first input device is designed to act on the functions of the second operating level, and in stand-by mode in readiness for operation, entries from the electronic telephone book are displayed on the display device via the electronic unit. The surprising advantage gained by the features defined in the characterizing part of claim 1 reside in the fact that the selection and design of the operating levels so that they have different sets of functions from one another makes operation in the first operating level easier, which makes it significantly easier and more intuitive for people not so well-versed to operate and handle the mobile telephone. In addition, via the first operating level, access is possible to only some selected functions of the total functions of the mobile telephone, which means that the range of available functions is kept relatively narrow. Programming and, associated with it, access to all the available functions, is only possible via the second operating level by means of the second input device, which has to be deliberately released or activated by the user. In this particular case, this is done by a relative displacement of the two housing parts with respect to one another. Accordingly, access to the second input device can be gained in the extended position only and via it the desired functions can be selected and run. In the so-called closed stand-by mode, entries from the electronic telephone book are always displayed on the display device, and the person to be called is selected by means of a navigation key in the first input device, which means that no additional search functions have to be activated.

Also of advantage is another embodiment defined in claim 3 because it permits a good overlap of the housing parts in the stand-by position on the one hand and in the extended or released position, unhindered access to the second input device can be enabled on the other hand.

Another embodiment defined in claim 4 is of advantage because the two housing parts can be displaced relative to one another by a simple sliding movement, thereby enabling reliable operation in both positions. Furthermore, the mechanical complexity of the requisite guides is kept low and the housing is also of a strong design.

Due to the embodiment defined in claim 5, it is possible to prevent access to the second input device in the stand-by position but easy access to the previously protected second input device is made possible in the extended or released position.

As a result of another embodiment defined in claim 6, a relative displacement of the two housing parts with respect to one another can be achieved in the peripheral region and hence in the region of the side faces, thereby resulting in a folding function in the manner of a book.

Also of advantage is another embodiment defined in claim 7 because a large-surface display of the entries displayed in display device is possible, thereby making them much easier to read.

The advantage of the embodiment defined in claim 8 is that a type of magnifying glass effect can be achieved, thereby resulting in a further enlargement of the entries displayed in the display device.

As a result of the embodiment defined in claim 9, a selected information or text field is highlighted by enlarging it accordingly, thereby further improving legibility.

As a result of the embodiment defined in claim 10 or 11, the display size of the information or text fields is improved and the sharpness of the display is significantly increased, which again results in a significant improvement in legibility.

Also of advantage are the embodiments defined in claims 12 to 14 because additional information may be read or seen on the display device in the stand-by position already and information can be displayed or retrieved directly without the need for a complicated menu selection.

As a result of an embodiment of the type defined in claim 15, easy access to the first input device is made possible in the stand-by position already, without any major risk of entering any inadvertent changes or settings on the mobile telephone.

In this respect, an embodiment defined in claim 16 has proved to be of advantage because it is possible to manage with a small number of operating keys, thereby making the mobile telephone easier to use.

As a result of the advantageous embodiments defined in claims 17 to 22, a relatively large design of the operating keys is obtained relative to the front face, which makes them significantly easier to find and then operate. In addition, the small number of operating keys makes handling and hence operating the mobile telephone significantly easier.

Also of advantage, however, is an embodiment defined in claim 23 or 24 because access to the second input device is reliably prevented in the stand-by position and operation is not possible until consciously released and hence the two housing parts have been moved relative to one another.

As defined in claim 25 or 26, access to all the functions of the second operating level is enabled, which means that the mobile telephone can be programmed by other persons.

In the embodiment defined in claim 27 or 28, the separate disposition of the two input devices with the operating keys or input keys forming them results in a design with a bigger surface area than is the case with conventional mobile telephones, thereby significantly facilitating and improving operation and manipulation of this mobile telephone.

Another possible embodiment is defined in claim 29, whereby any confusion between co-operating plug-in connections can be ruled out, which means that a whole range of external components can be easily connected to the mobile telephone without having to examine it closely.

The embodiment defined in claim 30 offers an additional display option, for example for incoming calls, SMS messages or similar, and thus improves the visual aspect and user-friendliness of the mobile telephone.

Also of advantage are the embodiments defined in claims 31 to 35, because they offer a simple way of placing a call for help, and operating modes of the mobile telephone can be set by the software-assisted and controlled electronic unit, which provide an easy way of establishing contact with the person seeking help, without the need for the person placing the call for help having to perform additional operating steps. This makes it possible for persons calling from outside to establish contact with the person in difficulty, even if it is no longer possible to operate the mobile telephone.

Another embodiment defined in claim 36 offers the possibility of enabling the mobile telephone to also be used in the form of a small pocket lamp, making it easier to find a lock or similar in the dark, for example.

Also of advantage is another embodiment defined in claim 37, which enables the power consumption to be kept relatively low.

The advantage of the embodiments defined in claim 38 and 39 is that it is possible to record images with the mobile telephone, and the focal length is adjusted by an optical zoom device, which significantly improves the image quality. Integrating the optical zoom device inside the housing avoids having to change the external dimensions of the housing, as would otherwise be the case if using known optical zoom devices, thereby resulting in a compact image recording device inside the mobile telephone that is relatively insensitive to interference.

Also of advantage are the embodiments defined in claims 40 to 42, because they offer other extra possible uses for the mobile telephone and voice or audio data can also be recorded in digital format for a longer or more extensive recording time in a high-quality format and then transmitted. This being the case, voice or audio data can be recorded for a period of up to one hour or more without having to provide additional memory capacity.

Independently of the above, the objective is also achieved by the invention on the basis of a method of saving at least one data set in an electronic telephone book of a mobile telephone, whereby the data set is prepared by means of another electronic device, for example a personal computer or another mobile telephone or a saved data set is retrieved, the data set is transferred from the electronic device to the mobile telephone and on receipt of a predefined code linked to the data set to be saved is saved in its telephone book on a totally automatic basis. The advantages gained from the combination of features defined in this claim are that relatives of the owner of a mobile telephone of this type can prepare data sets externally and then the data set or sets can be transferred to the mobile telephone, and when they are received by it in conjunction with a predefined code, they are totally automatically saved in the telephone book of the mobile telephone. This avoids having to run additional operations with the mobile telephone for saving purposes, which significantly improves and facilitates the way the mobile telephone is operated. There is no need to enter the corresponding data sets but corresponding data entries can be reliably saved without having to program the respective mobile telephone directly.

An approach as defined by the characterizing features of claim 44 is of advantage because it allows standard transmission means to be used, thereby guaranteeing a reliable transmission.

Another advantageous approach is defined in claim 45, whereby additional operation when saving the data set is avoided but current names and telephone numbers can be saved.

Another variant of the method defined in claim 46 is of advantage because depending on the control character on the receiving mobile telephone, a clear command structure is predefined as to how and by what means the transmitted data set is to be processed, and a predefinable type of additional processing can be run automatically depending on the code or coding.

The approach based on the characterizing features defined in claim 47 is of advantage because it offers a simple way of preparing telephone book entries externally and then assigning an additional predefined code to them so that they can be transmitted as an SMS message to the predefined mobile telephone. This ensures that only predefinable data sets in the receiving mobile telephone will be subjected to further processing.

However, the objective of the invention is also achieved independently by a method of securing individual items of data of a mobile telephone, whereby at least the data sets of the electronic telephone book for each SMS message are transferred to a memory device of a peripheral electronic device and archived for subsequent retrieval or back-up. The advantages gained as a result of the combination of features defined in this claim are that a user of such a mobile telephone can transfer data sets stored on it to an external memory device and archive them there so that the data sets can be backed-up to the mobile telephone again if necessary in the event of a data loss without the need for involved programming or new entries. This results in a high degree of security and even in the case of potential operating errors or inadvertent deletion, access to the important data of the telephone book is guaranteed.

An approach defined in claim 49 is of advantage because important personal settings of the mobile telephone can be externally stored or saved at the wish of the user and these initial settings can be moved back as and when required without incurring losses.

Finally, other advantageous approaches are defined in claims 50 to 54, whereby a data loss can be reliably prevented for a longer period and the last stored data sets can also be found again or retrieved. Furthermore, the transmission time and hence the security and completeness of the data are improved due to the fact that only data sets of a pre-definable volume or a pre-definable size are transmitted. The data exchange is also made highly secure by assigning a corresponding code, thereby preventing unauthorized access.

The invention will be explained in more detail below with reference to examples of embodiments illustrated in the appended drawings.

Of these:

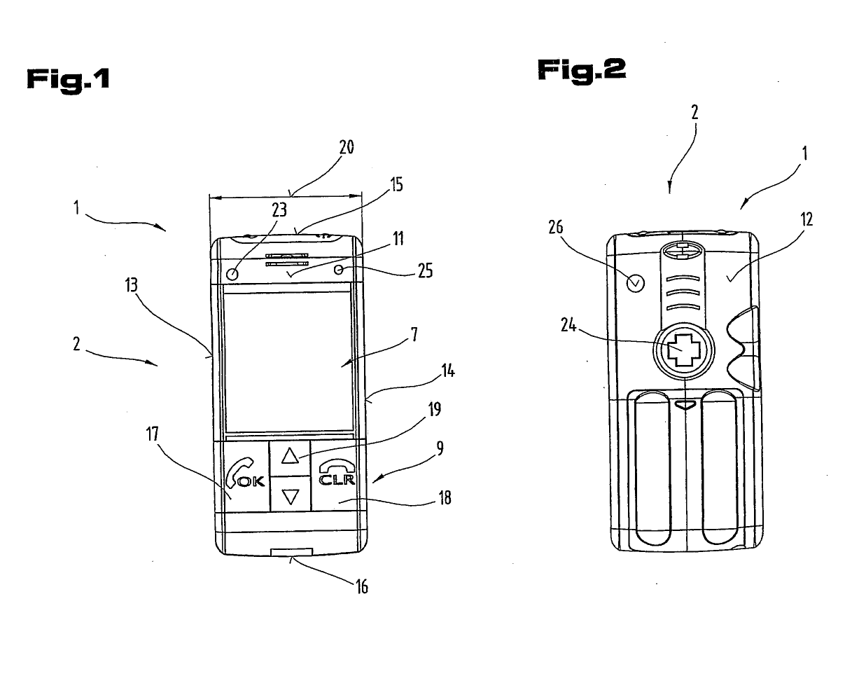

FIG. 1 is a simplified diagram showing a plan view of a mobile telephone proposed by the invention in its stand-by position;

FIG. 2 is a view of the mobile telephone illustrated in FIG. 1 seen from the rear;

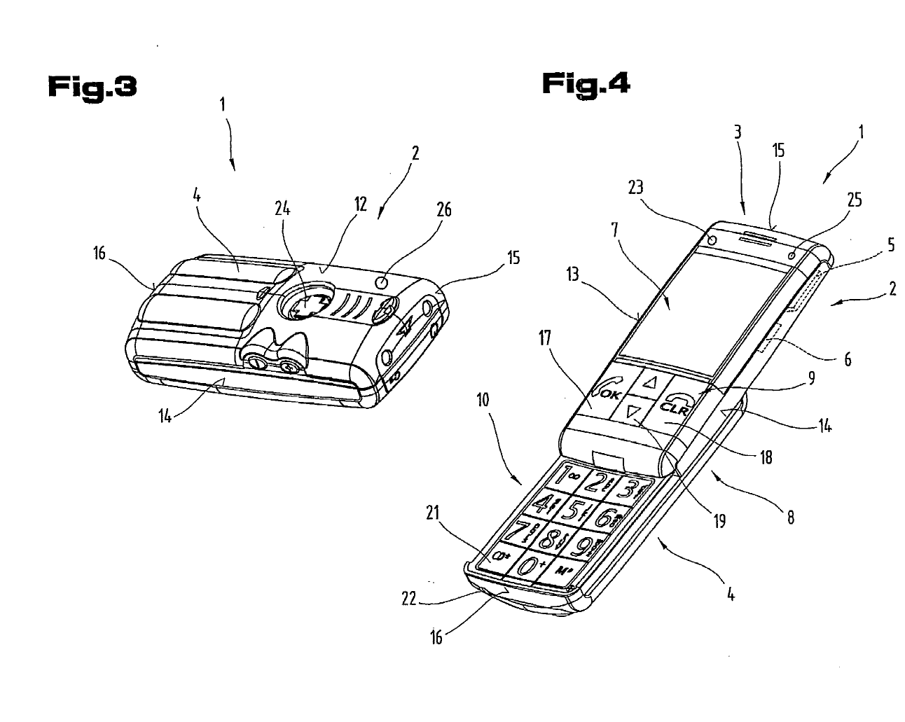

FIG. 3 is a simplified schematic diagram showing the mobile telephone illustrated in FIGS. 1 and 2 from the rear;

FIG. 4 is a simplified schematic diagram showing the mobile telephone illustrated in FIGS. 1 to 3, but in its bigger, extended mode;

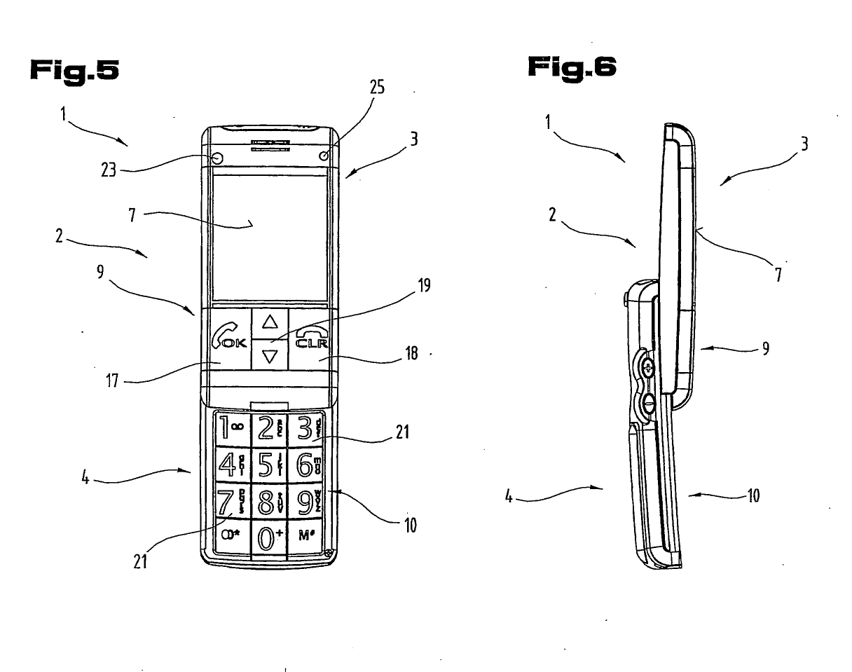

FIG. 5 is a plan view of the mobile telephone illustrated in FIG. 4;

FIG. 6 is a side view of the mobile telephone illustrated in FIGS. 4 and 5.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIGS. 1 to 6 provide a simplified illustration of a mobile telephone 1, comprising a housing 2 with at least a first and a second housing part 3, 4, which are connected to one another and can be displaced relative to one another, from a relatively compact stand-by position—see FIGS. 1 to 3—into a relatively larger extended position—see FIGS. 4 to 6—and vice versa.

The mobile telephone 1 also has at least one schematically illustrated electronic unit 5, an electronic memory device 6, a display device 7 and an input unit 8 with a first input device 9 and a second input device 10 disposed separately from the first input device 9.

It should be pointed out that the mobile telephone 1 described here is designed for all possible conversations conducted wirelessly and for the wireless transmission of information as well as for receiving, and may therefore also be of the type corresponding to cordless telephones, for example.

The first input device 9 in this instance co-operates with the first housing part 3 and the second input device 10 co-operates with the other housing part 4. The two input devices 9, 10, the display device 7 and optionally also the memory device 6 are actively connected and wired to the electronic unit 5.

As may best be seen from FIG. 1, the mobile telephone 1 or the housing 2 is in its compact stand-by position in which the housing 2 has a front face 11, a rear face 12 and side faces 13 to 16 extending in between.

Due to the approximately rectangular shape looking onto the front face 11, the two side faces 13, 14 constitute the longer side faces and the other side faces 15, 16 the shorter side faces. In the stand-by position, the display device 7 forms only a part-portion of the front face 11 and is disposed in it.

The mobile telephone 1 illustrated here has two operating levels with different sets of functions, and in a first operating level, access is limited to only some of the functions available in total, in particular to telephone functions such as accepting calls, establishing a telephone connection, terminating a conversation and telephone book selection. In the second operating level, however, all the functions can be accessed. The options for accessing the different operating levels in the embodiment illustrated as an example here are set so that in the stand-by position, access to the first operating level can be gained exclusively by or through the first input device 9 and the first input device 9 therefore acts on the functions in the first operating level. In the stand-by position or stand-by mode of the mobile telephone 1, the electronic unit 5 also causes entries from the data entries or data stored in the memory device 6 to be always displayed on the display device 7 without having to retrieve them from a selection menu.

In the stand-by position of the mobile telephone 1, in addition to the entries displayed from the electronic telephone book, the charge status or available capacity of the power supply source of the mobile telephone 1 and/or the reception strength and/or the possible arrival of SMS messages and/or missed calls and/or dialed call numbers are also displayed, and these latter functions can be accessed via the first operating level within its reduced set of functions by operating the first input device 9. The latter functions can also be accessed via the second input device 10 and thus via the second operating level, offering the full access options to the full set of functions. For example, in the stand-by position, the arrival of SMS messages is displayed on the display device 7 and these messages can be called up by selecting or choosing an information or look-up field of these messages. Also in the stand-by position, missed calls can be displayed on the display device 7 and more information about the caller, the time of the call, etc., can be called up by selecting or choosing an information or look-up field. On selecting or choosing an information or look-up field, more detailed information about dialed call numbers can be retrieved on the display device 7, and this is preferably possible via the first input device 9 and hence via the first reduced operating level.

In the extended position of the mobile telephone 1, as illustrated in FIGS. 4 to 6 for example, the second input device 10 between the housing parts 3, 4 is released. Access to the second input device 10 is therefore possible, and the second input device 10 is also designed to act on the functions of the second full operating level in combination with the first input device 9.

The relative displacement of the two housing parts 3, 4 with respect to one another may take place in various ways and in the instance illustrated here is based on an approximately parallel sliding of the housing parts 3, 4 with respect to one another. However, it would also be possible to opt for slightly curved displacement paths and this will depend on the shape of the external contour of the housing 2. In this instance, the two housing parts 3, 4 can be moved relative to one another more or less parallel with the front face 11 and rear face 12, and this relative displacement takes place in the direction of the two longer side faces 13, 14. However, another option would be a relative rotation of the two housing parts 3, 4 with respect to one another in a pivot plane or rotation plane oriented approximately parallel with the front face 11 and rear face 12. Another option would be a folding movement of the two housing parts 3, 4 relative to one another, in which case a pivot or rotation pin connecting the housing parts 3, 4 is oriented approximately parallel with and in the direction of one of the side faces 13 to 17.

As already described above, the front face 11 is laterally bounded by the side faces 13 to 16 and in order to provide a better and bigger display of the entries, the display device 7 may have a surface extension amounting to at least 40% of the front face 11 in the compact stand-by position. However, it is also of advantage if the surface extension of the display device 7 is between 25% and 70%, preferably between 30% and 50%, of the front face 11 in the stand-by position. A further magnification of the display in the display device 7 can be achieved if it curves by reference to the front face 11, in particular is convexly curved, thereby producing a magnifying glass effect to enable the entries to be displayed on the display device 7 in an even bigger format. Better legibility of an information or text field presented in the display device 7 can be achieved if the presentation itself is magnified by between 15% and 70%, preferably between 25% and 50%, on selecting or choosing this information or text field. Improved legibility of the information displayed in the information or text field of the display device 7 is achieved if the display device 7 has a resolution of between 160×160 pixels and 256×256 pixels. Legibility can also be improved if the display device 7 is of a minimum size of 35×40 mm, preferably approximately 45×50 mm, thereby enabling a bigger presentation of numbers and letters.

In order to make handling of the of the mobile telephone 1 easier and more intuitive, the first input device 9 with access to only some of the total functions is disposed in the front face 11 of the first housing part, this instance 3 facing a user, and has a maximum of three operating keys 17 to 19 or a maximum of four electric push-button elements for only some of the available functions, which in this instance are the telephone functions. The individual operating keys 17 to 19 of the first input device 9 are disposed adjacent to one another in this instance and extend in sum across a total width 20 of the housing 2. The housing 2 may have a front face 11 with dimensions of 55 mm×115 mm and a thickness or depth of between 20 mm and 27 mm, for example. What in this instance are the shorter side faces 15, 16 therefore have a width 20 with a dimension of 55 mm. Other dimensions would also be possible, in which case mobile telephones 1 for women may be of slightly smaller dimensions. What in this instance are the two outer operating keys 17, 18 may have a width of 20 mm and a height of 24 mm, for example. The centrally disposed operating key 19—in this instance a navigation key—may have a width of 15 mm and a same height of 24 mm, for example.

To improve ease of use, especially for older and/or sight-impaired persons, it is of advantage if the operating keys 17 to 19 occupy between 10% and 25%, preferably 20%, of the front face 11 in the stand-by position and the latter occupy approximately the same surface area as one another. The first and, as illustrated in FIG. 1, left-hand first operating key 17 in this example of an embodiment is a key for accepting calls and making calls, whilst the other operating key 18 illustrated on the right-hand side in FIG. 1 is a key for terminating a conversation and for refusing calls and, finally, the third operating key 19 is used for selecting and as a navigation key. The third operating key 19 is disposed between the two operating keys 17 and 18 and has two possible navigation directions in the display menu presented on the display device 7.

To enable access to all the functions of the set of functions in the embodiment illustrated as an example here, it is necessary to move the two housing parts 3, 4 relative to one another into the bigger extended position in order to permit mechanical access to the second input device 9. In this respect, the second input device 9 is disposed on the side of the second housing part 4 facing away from the rear face 12 of the housing 2. Accordingly, in the extended position, the second input device 9 as well as the first input device 9 are disposed facing the user, as is the front face 11. In order to protect against undesired access or inadvertent changes to stored personal settings of the mobile telephone 1, the second input device 10 can not be accessed until after the relative displacement of the two housing parts 3, 4 from the stand-by position, in which the two housing parts 3, 4 overlap preferably in at least certain portions, into the extended position to release access. For safety reasons during operation and because of the compactness of the mobile telephone 1, the two housing parts 3, 4 overlap completely at their mutually facing sides in the stand-by position.

In a manner known per se, the second input device 10 has several input keys 21 for numbers and characters and constitutes an alphanumeric key pad. This being the case, the second input device 10 preferably has at least twelve of these input keys 21, although it would also be possible to provide up to fourteen input keys 21. To make the input keys 21 of the second input device 10 easier to use, they may occupy a surface extension of between 30% and 60%, preferably between 35% and 45%, of the front face 11 in the stand-by position of the mobile telephone 1. The overall key pad of input keys 21 in the embodiment illustrated as an example may have dimensions of 45 mm×60 mm if there are twelve input keys 21. This being the case, the individual keys occupy an area of 225 mm². Simple operation in terms of finding and operating the two input devices 9 and/or 10 is obtained if the operating keys 17 to 19 and input keys 21 are of a minimum size of 80 mm². This relatively large surface area occupied by the operating keys 17 to 19 and input keys 21 makes operation of such a mobile telephone 1 significantly easier, even for older or not so well-versed persons.

It is also possible to provide a single, coupling device 22 on the housing 2 for different elements which can be coupled with it, such as a charger, data cable, loudspeaker, headphones, etc. This avoids the inconvenience of having to look for the associated coupling parts, which reduces the risk of mixing them up and largely prevents potential damage. In order to make it more obvious or easier to see that a call is waiting and/or an SMS has arrived, at least one additional optical display element 23 may be provided on the housing 2, in particular in the region of the front face 11, as schematically indicated by a circle in the region of the front face 11 in FIG. 1.

In order to signal an emergency situation, an input means may also be provided or disposed on the housing 2, which, in the embodiment illustrated as an example here, is provided in the form of an emergency call key 24 disposed in the rear face 12 of the housing 2 gebildet. However, this input means may also be disposed in any other position on the housing 2, such as in the region of one of the side faces 13 to 16, for example, or optionally also in the region of the front face 11. In this connection, the software-controlled electronic unit 5 may be programmed to accept every incoming call automatically and switch it to a hands-free mode of the mobile telephone 1 in the event of an unsuccessfully placed emergency call or if an emergency call has not been accepted or registered by a called emergency center. The electronic unit 5 may also be programmed to automatically accept a call in hands-free mode after a limited time if an emergency call has been unsuccessful, in which case this will preferably take place within a period of one hour. However, the electronic unit 5 may also be programmed to accept calls on a fully automated or automatic basis. Due to the software-controlled automated acceptance of incoming calls described above and the additional switch to hands-free mode, persons who have had an accident will be able to provide the caller with information about the accident and their condition without having to operate the mobile telephone 1 directly. This would be the case if, for example, a person had placed an emergency call but this person were no longer capable of operating the mobile telephone 1, which means that the person requiring assistance would still be able to hold a conversation with the other person calling back.

As also illustrated on a simplified basis in the top right-hand region of the front face 11 in FIG. 5, at least one additional lamp means 25 is provided on the housing 2 or mobile telephone 1 for illuminating the immediately surrounding area, and this lamp means 25 may be provided in the form or one or more light-emitting diodes for lighting the surrounding area. It should be pointed out that the position or disposition of the lamp means 25 on the housing 2 and the type of lamp means, namely light-emitting diodes, represent one of many possible options. A light-emitting diode is used due to the fact that it has low power consumption but still emits sufficient light.

Furthermore, it would also be possible to integrate a digital camera 26 with an optical zoom device, although this is not illustrated, in the mobile telephone 1 or its housing 2, as schematically illustrated in the region of the rear face 12 in FIG. 3. This optical zoom device comprises at least one mirror or some other deflector system, as well as several lenses which can be displaced relative to one another for the light irradiated from an image to be recorded. The optical zoom device and the associated relative displacement of the lenses and components constituting the digital camera are such that during the displacement of the zoom area, the external dimensions of the housing 2 are not changed by projecting parts of the parts forming the digital camera 26 and the external dimensions of the housing 2 therefore remain unchanged during the relative displacement of the components constituting the zoom device. Consequently, the adjustment of the focal length of the digital camera 26 takes place inside the housing 2 and in the embodiment illustrated here, a light-transparent orifice is provided in the region of the rear face 12 only to provide a passage for the light from the image to be recorded, which is closed by a guard element and/or a lens. This optical zoom device results in a better image quality than can be achieved with digital zoom devices of other digital cameras. The intension is to enable a piece to be cut from an existing image with a pre-definable resolution and then digitally enlarged, which results in a loss of quality. With the optical zoom device, a perfect recording of the light and corresponding reproduction of the recorded image can be achieved without having to make any external change to the housing 2 and its housing parts 3, 4.

The mobile telephone 1 may also be provided with a digital speech recording device, in which case a recording device may be provided in the region of the front face 11, in its top peripheral area in the region of the slot-shaped orifices, as illustrated in FIG. 1 for example. This speech recording device also has a compressing means for digital voice or audio data, and the compressing means is designed to create data sets in DSS-Format (Digital Speech Standard). To this end, the electronic unit 5 is configured for transmitting the recorded digital voice or audio data via a wireless communication link, in particular via a GSM link (Global System for Mobile communication), a GPRS link (General Packet Radio Service) or a UMTS link (Universal Mobile Communication System) to an electronic mail address or e-mail address. Voice or audio data can also be recorded for longer or more extensive periods of one hour or more, for example, in a corresponding quality, directly by means of the mobile telephone 1 and then transmitted via one of the above-mentioned systems to the desired electronic message address or e-mail address.

In order to make it easier for the user of such a mobile telephone to save data sets in the electronic telephone book of a mobile telephone 1, the data set to be saved is created externally with another electronic device, for example a personal computer or another mobile telephone, or retrieved from a stored data set, the data set is transmitted from the electronic device to the mobile telephone 1 and on receipt of a predefined code, the latter is saved in its telephone book together with the data set to be stored on a fully automatic basis. Accordingly, it is possible for users of this mobile telephone 1 to save entries based on data sets in its electronic telephone book or telephone directory, and the process of saving in memory takes place completely automatically and without the need for further intervention due to the predefined code. The transfer may take place via an SMS message (Short Message Service) for example. The predefined code described above is evaluated and converted as an electronic memory command by the mobile telephone 1 receiving the data set. As a code or coding for the data set to be transmitted, at least one defined control character, for example a hash sign, is added. The data set is created in the electronic telephone book as a telephone book entry with a name and/or call number and transmitted together with the predefined code or coding as an SMS message.

In order to secure individual data items and/or settings of the mobile telephone 1, it is possible to transfer at least one but preferably several of these data sets of the electronic telephone book via SMS message to a memory device of a peripheral electronic device and archive them for subsequent retrieval or back-up from the memory device of the peripheral device. The personal settings of the mobile telephone 1 can also be transmitted via SMS message to the memory device of the peripheral electronic device as separate data sets. The data sets can be sent to the external memory device at recurring periods to avoid the loss of too large an amount of data. The data sets can also be transferred to the external memory device as a function of the amount of data sets stored.

On request, using a mobile telephone 1 identified as being authorized by means of a call number code, the data sets archived in the peripheral electronic device can be transmitted back, in which case an appropriate prompt command with a predefined content or predefined code is generated by an SMS message. The external electronic device may be a data server operated by a service provider.

The power supply is not illustrated in detail but may be provided either in the form of a specific rechargeable accumulator block or by standard batteries inserted in the battery compartment, and the appropriate terminals or contact tabs for whichever variant is used are provided.

The embodiments illustrated as examples represent possible design variants of the mobile telephone 1, and it should be pointed out at this stage that the invention is not specifically limited to the design variants specifically illustrated, and instead the individual design variants may be used in different combinations with one another and these possible variations lie within the reach of the person skilled in this technical field given the disclosed technical teaching. Accordingly, all conceivable design variants which can be obtained by combining individual details of the variants described and illustrated are possible and fall within the scope of the invention.

For the sake of good order, finally, it should be pointed out that, in order to provide a clearer understanding of the structure of the mobile telephone 1, it and its constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1 to 6 constitute independent solutions proposed by the invention in their own right. The objectives and associated solutions proposed by the invention may be found in the detailed descriptions of these drawings.

### LIST OF REFERENCE NUMBERS

1 Mobile telephone
2 Housing
3 Housing part
4 Housing part
5 Electronic unit
6 Memory device
7 Display device
8 Input unit
9 Input device
10 Input device
11 Front face
12 Rear face
13 Side face
14 Side face
15 Side face
16 Side face
17 Operating key
18 Operating key
19 Operating key
20 Width
21 Input key
22 Coupling device
23 Display element
24 Emergency call key
25 Lamp means
26 Digital camera

1-54. (canceled)

55. Mobile telephone (1) comprising a housing (2) with at least a first and a second housing part (3, 4) which can be connected to one another and displaced relative to one another from a relatively compact stand-by position into a relatively larger extended position and vice versa, at least one electronic unit (5), an electronic memory device (6) for at least storing data for an electronic telephone book, a display device (7) and an input unit (8) with a first input device (9) and a second, input device (10) disposed separately from the first input device (9), and the first input device (9) co-operates with the first housing part (3) and the second input device (10) co-operates with the second housing part (4), and the two input devices (9, 10), display device (7) and memory device (6) are actively connected to the electronic unit (5), and in the stand-by position the housing (2) has a front face (11), a rear face (12) and side faces (13 to 16) extending in between, and the display device (7) occupies a part-portion of the front face (11), and the mobile telephone (1) also has a first and a second operating level with different sets of functions, and access to all the functions is enabled in a second operating level, and in the stand-by position, access is possible to the first input device (9) exclusively and the first input device (9) acts on the functions of the first operating level, and in a first operating level access is limited to only some of all the available functions, and in a second operating level all the functions can be accessed, and in the extended position, the second input device (10) can be accessed in addition, and the second input device (10) is programmed to act on the functions of the second operating level in combination with the first input device (9), wherein in the stand-by position the telephone functions, such as accepting calls, establishing telephone connections, terminating a conversation and telephone book selection, can be activated via the first input device (9), and entries from the electronic telephone book are displayed via the electronic unit (5) on the display device (7) in stand-by mode in the stand-by position.

56. Mobile telephone (1) comprising a housing (2), at least one electronic unit (5), a display device (7) and an input unit (8) with at least one input device (9, 10), and the input unit (8) as well as the display device (7) are actively connected to the electronic unit (5).

57. Mobile telephone (1) according to claim 55, wherein the two housing parts (3, 4) can be displaced relative to one another approximately parallel with the front face (11) and rear face (12).

58. Mobile telephone (1) according to claim 55, wherein relative displacement is effected in the direction of the longer side faces (13, 14).

59. Mobile telephone (1) according to claim 55, wherein the relative displacement is effected in a pivot or rotation plane oriented approximately parallel with the front face (11) and rear face (12) by mutually turning the two housing parts (3, 4) with respect to one another.

60. Mobile telephone (1) according to claim 55, wherein the relative displacement is effected by means of a folding movement of the two housing parts (3, 4) with respect to one another and a pivot or rotation pin connecting the housing parts (3, 4) is oriented approximately parallel with and in the direction of one of the side faces (13 to 16).

61. Mobile telephone (1) according to claim 55, wherein the display device (7) has a surface extension corresponding to between 25% and 70%, preferably between 30% and 50%, of the front face (11) in the stand-by position.

62. Mobile telephone (1) according to claim 55, wherein the display device (7) is of a curved design by reference to the front face (11), in particular is convexly curved.

63. Mobile telephone (1) according to claim 55, wherein the actual display on the display device (7) when an information or text field is selected or chosen is magnified by 15% and 70%, preferably between 25% and 50%.

64. Mobile telephone (1) according to claim 55, wherein the display device (7) has a resolution of between 160×160 and 256×256 pixels.

65. Mobile telephone (1) according to claim 55, wherein the display device (7) has a minimum size of 35×40 mm, preferably approximately 45×50 mm.

66. Mobile telephone (1) according to claim 55, wherein the arrival of SMS messages is displayed on the display device (7) in stand-by mode and these messages can be retrieved by selecting or choosing an information or look-up field.

67. Mobile telephone (1) according to claim 55, wherein missed calls are displayed on the display device (7) in stand-by mode and more detailed information about the caller can be retrieved by selecting or choosing an information or look-up field.

68. Mobile telephone (1) according to claim 55, wherein more detailed information about selected call numbers is displayed on the display device (7) when an information or look-up field is selected or chosen.

69. Mobile telephone (1) according to claim 55, wherein the first input device (9) is disposed in the front face (11) of the first housing part (3).

70. Mobile telephone (1) according to claim 55, wherein the first input device (9) has a maximum of three operating keys (17 to 19) or a maximum of four electric push-button elements for the telephone functions.

71. Mobile telephone (1) according to claim 70, wherein the operating keys (17 to 19) are disposed adjacent to one another and in total extend across an entire width (20) of the housing (2).

72. Mobile telephone (1) according to claim 70, wherein the operating keys (17 to 19) occupy between 10% and 25%, preferably 20%, of the front face (11) in the stand-by position.

73. Mobile telephone (1) according to claim 70, wherein the operating keys (17 to 19) occupy approximately the same surface extension as one another.

74. Mobile telephone (1) according to claim 70, wherein the first operating key (17) is a key for accepting calls and making calls.

75. Mobile telephone (1) according to claim 70, wherein the other operating key (18) is a key for terminating a conversation or refusing a call.

76. Mobile telephone (1) according to claim 70, wherein the third operating key (19) is a selection key or navigation key with two possible navigation directions in a display menu of the display device (7).

77. Mobile telephone (1) according to claim 55, wherein the second input device (10) is disposed on the side of the second housing part (4) facing away from the rear face (12) of the housing (2).

78. Mobile telephone (1) according to claim 55, wherein the second input device (10) can be accessed and is released after the relative displacement of the two housing parts (3, 4) from the stand-by position, in which the two housing parts (3, 4) overlap in at least certain sections, into the extended position.

79. Mobile telephone (1) according to claim 55, wherein the second input device (10) has several input keys (21) for numbers and characters, in particular an alphanumeric key pad.

80. Mobile telephone (1) according to claim 55, wherein the second input device (10) has at least twelve input keys (21).

81. Mobile telephone (1) according to claim 55, wherein the input keys (21) of the second input device (10) have a surface extension of between 30% and 60%, preferably between 35% and 45%, of the front face (11) in the stand-by position of the mobile telephone (1).

82. Mobile telephone (1) according to claim 55, wherein the operating keys (17 to 19) and input keys (21) are of a minimum size of 80 mm².

83. Mobile telephone (1) according to claim 55, wherein a single coupling device (22) is provided on the housing (2) for different elements which can be coupled with it, such as a charger, data cable, loudspeaker.

84. Mobile telephone (1) according to claim 55, wherein at least one additional optical display element (23) is provided on the housing (2), in particular in the region of the front face (11).

85. Mobile telephone (1) according to claim 55, wherein an input means for signaling an emergency situation is provided on the housing (2).

86. Mobile telephone (1) according to claim 85, wherein the input means is provided in the form of an emergency call key (24) preferably disposed in the rear face (12) of the housing (2).

87. Mobile telephone (1) according to claim 85, wherein if an emergency call has not been successfully placed or if an emergency call is not taken or not recorded by the at least one called emergency call center, the software-controlled electronic unit (5) is programmed to accept any incoming call and switch to a hands-free mode automatically.

88. Mobile telephone (1) according to claim 87, wherein within a limited time after an emergency call has been placed, in particular within one hour, the electronic unit (5) is programmed to accept a call in hands-free mode automatically.

89. Mobile telephone (1) according to claim 87, wherein the electronic unit (5) is programmed to accept calls on a fully automatic basis.

90. Mobile telephone (1) according to claim 55, wherein it has at least one additional lamp means (25) for illuminating the immediately surrounding area.

91. Mobile telephone (1) according to claim 90, wherein the lamp means (25) for illuminating the immediately surrounding area is provided in the form of at least one light-emitting diode.

92. Mobile telephone (1) according to claim 55, wherein it has a digital camera (26) with an optical zoom device.

93. Mobile telephone (1) according to claim 92, wherein the optical zoom device comprises at least one mirror or some other deflector device as well as several lenses which can be displaced relative to one another for the light irradiated from an image to be recorded, and when the components making up the zoom device are displaced relative to one another, the external dimensions of the housing (2) remain unchanged.

94. Mobile telephone (1) according to claim 55, wherein it has a digital speech recording device and a compression means for digital voice or audio data.

95. Mobile telephone (1) according to claim 94, wherein the compressing means is designed to create data sets in DSS format (Digital Speech Standard).

96. Mobile telephone (1) according to claim 94, wherein the electronic unit (5) is designed for sending digital voice or audio data via a wireless communication link, in particular via a GSM link (Global System for Mobile communication), GPRS link (General Packet Radio Service), or a UMTS link (Universal Mobile Communication System), to an electronic mail address or e-mail address.

97. Method of securing individual data of a mobile telephone (1), whereby data sets are transferred by SMS message to a memory device (6) of a peripheral electronic device and archived for subsequent retrieval or back-up, wherein the data sets are formed by the personal settings of the mobile telephone (1).

98. Method according to claim 97, wherein data sets of the electronic telephone book are transmitted by SMS message.

99. Method according to claim 97, wherein the data sets are transmitted to the external memory device (6) on a periodically recurring basis.

100. Method according to claim 97, wherein the data sets are transmitted to the external memory device (6) as a function of the quantity of stored data sets.

101. Method according to claim 97, wherein when prompted by a mobile telephone (1) recognized as authorized by a call number code, data sets archived in the peripheral electronic device are transferred to the latter.

102. Method according to claim 101, wherein a prompt command is formed by an SMS message with predefined content and a predefined code.

103. Method according to claim 97, wherein the peripheral or external electronic device is a data server operated by a service provider.
